(19) United States
(12) Patent Application Publication
(10) Pub. No.: US 2010/0187178 A1
(43) Pub. Date: Jul. 29, 2010

(54) Process for removing and sequestering contaminants from aqueous streams

(75) Inventors: John Leslie Burba, Parker, CO (US); Richard Donald Witham, Boulder City, NV (US); Edward Bayer McNew, Las Vegas, NV (US)

Correspondence Address: SHERIDAN ROSS PC, 1560 BROADWAY, SUITE 1200, DENVER, CO, 80202, US

(73) Assignee: Molycorp Minerals, LLC, Greenwood Village, CO (US)

(21) Appl. No.: 12/632,523

(22) Filed: Dec. 7, 2009

Related U.S. Application Data
(63) Continuation-in-part of application No. 11/925,247, filed on Oct. 26, 2007, now Pat. No. 7,686,976.
Application No. 11/925,247 is a division of application No. 11/435,697, filed on May 16, 2006, now Pat. No. 7,300,589.
Application No. 11/435,697 is a division of application No. 11/029,257, filed on Jan. 5, 2005, now Pat. No. 7,048,853.
Application No. 11/029,257 is a division of application No. 10/353,705, filed on Jan. 29, 2003, now Pat. No. 6,863,825.

(51) Int. Cl. C02F 1/58; C02F 1/52; C02F 1/72; C02F 1/28; C02F 1/42; C02F 5/08; C09K 3/00

(52) U.S. Cl. 210/665; 210/721; 210/287; 210/282; 252/186.1

(57) ABSTRACT

Contaminants, including arsenic, are removed from water and other aqueous feeds preferably by (1) treating the feed with a compound containing a rare earth (e.g., cerium in the +4 oxidation state, preferably cerium dioxide), to oxidize contaminants in the +3 oxidation state to arsenic in the +5 oxidation state and (2) removing the contaminants in the +5 oxidation state from the aqueous phase, normally by contacting the treated feed with a rare earth-containing precipitating agent.

### CROSS-REFERENCE TO RELATED APPLICATIONS

The present application is a continuation-in-part of U.S. application Ser. No. 11/925,247, filed Oct. 26, 2007, which is a division of U.S. application Ser. No. 11/435,697, filed May 16, 2006, now U.S. Pat. No. 7,300,589, which is a division of U.S. application Ser. No. 11/029,257, filed Jan. 5, 2005, now U.S. Pat. No. 7,048,853, which is a division of U.S. application Ser. No. 10/353,705, filed Jan. 29, 2003, now U.S. Pat. No. 6,863,825, each of which is incorporated fully herein in its entirety.

### BACKGROUND OF INVENTION

This invention relates generally to methods, compositions and devices for removing arsenic from aqueous streams and is particularly concerned with methods, compositions and devices for removing arsenic from groundwater and drinking water using cerium in the +4 oxidation state to oxidize arsenic so it can be precipitated from the water.

Arsenic is a toxic element that naturally occurs in a variety of combined forms in the earth. Its presence in natural waters may originate, for example, from geochemical reactions, industrial waste discharges and past agricultural uses of arsenic-containing pesticides. Because the presence of high levels of arsenic may have carcinogenic and other deleterious effects on living organisms, the U.S. Environmental Protection Agency (EPA) and the World Health Organization have set the maximum contaminant level (MCL) for arsenic in drinking water at 10 parts per billion (ppb). Arsenic concentrations in wastewaters, groundwaters, surface waters and geothermal waters frequently exceed this level. Thus, the current MCL and any future decreases, which may be to as low as 2.0 ppb, create the need for new techniques to economically and effectively remove arsenic from drinking water, well water and industrial waters.

Arsenic occurs in four oxidation or valence states, i.e., −3, 0, +3, and +5. Under normal conditions arsenic is found dissolved in aqueous or aquatic systems in the +3 and +5 oxidation states, usually in the form of arsenite (AsO₂⁻¹) and arsenate (AsO₄⁻³). The effective removal of arsenic by coagulation techniques requires the arsenic to be in the arsenate form. Arsenite, in which the arsenic exists in the +3 oxidation state, is only partially removed by adsorption and coagulation techniques because its main form, arsenious acid (HAsO₂), is a weak acid and remains un-ionized at a pH between 5 and 8 where adsorption takes place most effectively.

Various technologies have been used in the past to remove arsenic from aqueous systems. Examples of such techniques include adsorption on high surface area materials, such as alumina and activated carbon, ion exchange with anion exchange resins, co-precipitation and electrodialysis. However, most technologies for arsenic removal are hindered by the difficulty of removing arsenite. The more successful techniques that have been used in large municipal water supplies are not practical for residential applications because of space requirements and the need to use dangerous chemicals. The two most common techniques for residential water treatment have been reverse osmosis and activated alumina. The former method produces arsenic-containing waste streams that must be disposed of, and the latter requires the use of caustic chemicals.

The above facts coupled with the potential for the decrease in MCL to between 2 and 10 ppb make it imperative that effective processes, compositions and devices for removing arsenic from water and other aqueous systems be developed.

### SUMMARY OF THE INVENTION

In accordance with the invention, it has now been found that arsenic and other contaminants can be efficiently and effectively removed from water and other aqueous feedstocks by treating the contaminant-containing aqueous feed with an oxidant, preferably a compound containing cerium in the +4 oxidation state and even more preferably cerium dioxide (CeO₂), to oxidize the arsenic so that it can be more easily removed by precipitation or another suitable technique from the treated aqueous feed to produce a purified aqueous liquid with a reduced contaminant concentration. “Precipitation” as used herein encompasses not only the removal of contaminant-containing ions in the form of insoluble species, but also includes the immobilization of contaminant-containing ions on or in insoluble particles. For example, “precipitation” includes techniques such as adsorption and absorption. “Inorganic contaminant”, as used herein, includes not only arsenic and complex arsenic anions, but also oxyanions of an element having an atomic number selected from the group consisting of 5, 13, 14, 22 to 25, 31, 32, 34, 40 to 42, 44, 45, 49 to 52, 72 to 75, 77, 78, 80, 81, 82, 83 92, 94, 95, and 96. These elements include boron, aluminum, silicon, titanium, vanadium, chromium, manganese, gallium, thallium, germanium, selenium, mercury, zirconium, niobium, molybdenum, ruthenium, rhodium, indium, tin, antimony, tellurium, hafnium, tantalum, tungsten, rhenium, iridium, platinum, lead, plutonium, americium, curium, and bismuth. Uranium with an atomic number of 92 is an example of a radioactive contaminant that may be present in the feed. For purposes of this invention, oxyanions include any anion containing oxygen in combination with one or more other elements. Although the invention is discussed primarily with reference to arsenic and its species, arsenate and arsenite, it is to be understood that the teachings of this invention apply equally to the other non-arsenic elements listed above.

In one embodiment of the process of the invention, water or other aqueous liquid containing dissolved arsenic in the +3 and +5 oxidation states is contacted with cerium dioxide to oxidize arsenic in the +3 oxidation state to arsenic in the +5 oxidation state, and the arsenic in the +5 oxidation state is removed from the aqueous liquid by contacting the liquid with a precipitating agent that reacts with the arsenic in the +5 oxidation state to produce insoluble arsenic compounds and an aqueous liquid of reduced arsenic content.

Typically, the oxidized arsenic is in the +5 oxidation state and dissolved in the water or other aqueous liquid in the form of arsenate (AsO₄⁻³). The precipitating agent used to remove the oxidized arsenic from the aqueous liquid can be anything that reacts with the arsenate or other form of oxidized arsenic to produce insoluble arsenic compounds. For example, the precipitating agent can be cerium in the +3 oxidation state produced in the arsenic oxidation step when cerium in the +4 oxidation state is reduced. Alternatively, the precipitating agent can be any particulate solid containing cations in the +3 oxidation state, such as alumina, aluminosilicates, ion exchange resin and clays.

The oxidation and precipitation steps can be carried out in the same or separate zones. If the steps are carried out in the same zone, the compound containing cerium in the +4 oxidation state is usually mixed with the precipitating agent. Although this mixture can be made by supporting the cerium compound on the surface and/or in the pores of the precipitating solids, it is usually preferred that the cerium compound in particulate form be physically mixed with particles of the precipitating agent. A preferred composition of the invention comprises a mixture of cerium dioxide and alumina.

In a preferred embodiment of the process of the invention, an aqueous liquid containing dissolved arsenic in the form of arsenate and arsenite is contacted with a mixture of cerium dioxide particulates and alumina particulates in an oxidation zone such that the cerium dioxide oxidizes the arsenite to arsenate and the alumina reacts with the arsenate to form insoluble aluminum arsenate that sorbs onto the particles of alumina. The aqueous liquid exiting the oxidation zone contains a substantially reduced concentration of arsenic, usually less than about 2.0 ppb.

### DETAILED DESCRIPTION OF THE INVENTION

Although the process of the invention is primarily envisioned for removing dissolved arsenic from drinking water and groundwater, it will be understood that the process can be used to treat any aqueous liquid feed that contains undesirable amounts of arsenic. Examples of such liquid feeds include, among others, well water, surface waters, such as water from lakes, ponds and wetlands, agricultural waters, wastewater from industrial processes, and geothermal fluids. In addition to arsenic, the feed can also contain other inorganic contaminants, such as selenium, cadmium, lead and mercury, and certain organic contaminants. As used herein, “organic contaminant” refers to all compounds of carbon except such binary compounds as the carbon oxides, the carbides, carbon disulfide, etc.; such ternary compounds as the metallic cyanides, metallic carbonyls, phosgene, carbonyl sulfide, etc.; and the metallic carbonates, such as calcium carbonate and sodium carbonate and “contaminant” includes both inorganic and organic contaminants. Generally, the process of the invention can be used to treat any aqueous liquid feedstock containing more than 2.0 ppb contaminant and is effective for treating feeds containing 30 more than 500 ppb contaminant. The process is effective in decreasing the contaminant levels in such feeds to below 5.0 ppb, usually to below 2.0 ppb.

The contaminant contaminating the aqueous feed is normally dissolved in the aqueous phase and usually exists in both the +3 and +5 oxidation states. Arsenic in the +3 and +5 oxidations states, respectively, is arsenite (AsO₂⁻¹) and arsenate (AsO₄⁻³). Techniques for removing arsenate exist and are quite effective, but removing the arsenite is a more difficult proposition because the present technologies for doing so are not greatly effective. It has now been found that substantially all of the dissolved arsenite can be easily oxidized to arsenate by treating the aqueous feed with cerium in the +4 oxidation state and the resulting arsenate, along with the arsenate originally present in the aqueous feed, precipitated from the treated feed to produce an arsenic-depleted aqueous liquid.

In the process of the invention, the aqueous feed contaminated with arsenic is passed through an inlet into an oxidation vessel at a temperature and pressure, usually ambient conditions, such that the water in the feed remains in the liquid state. If the feed is contaminated with particulate solids, it is usually treated to remove the solids before it is passed into the oxidation vessel. Any liquid-solids separation technique, such as filtration, centrifuging and hydrocycloning, can be used to remove the particulate solids.

In the oxidation vessel the aqueous feed is contacted with an oxidant or oxidizing agent, preferably a compound containing cerium in the +4 oxidation state (hereinafter referred to as cerium +4). Ce +4 is an extremely strong oxidizing agent and oxidizes any contaminant (e.g., arsenite or other arsenic present in the +3 oxidation state) to an oxidized contaminant (e.g., arsenate or other species containing arsenic in the +5 oxidation state). In addition to other rare earth oxidants, non-rare earth oxidants may be employed. Examples include peroxygen compounds (e.g., peroxide, permanganate, persulfate, etc.), ozone, chlorine, hypochlorite, Fenton's reagent, molecular oxygen, phosphate, and the like. All of the contaminant species containing the contaminant in the higher oxidation state is then precipitated from the aqueous phase by contacting the oxidized aqueous feed with a precipitating agent.

In one process configuration, the oxidizing agent is any solid or liquid containing cerium in the +4 oxidation state. Although it is generally preferred to use solid particles of cerium dioxide, which are insoluble in water and relatively attrition resistant as the oxidizing agent, water-soluble cerium compounds can also be used. Examples of such compounds include ceric ammonium nitrate, ceric ammonium sulfate, ceric sulfate, and ceric nitrate.

The precipitating agent that reacts with the arsenate containing arsenic in the +5 oxidation state to form insoluble arsenic compounds can be present in the oxidation vessel with the cerium +4 compound so that the precipitation occurs essentially simultaneously with the oxidation. Alternatively, it can be in a separate vessel into which the treated liquid exiting the oxidation vessel passes. For simplicity purposes, it is normally preferred for both the cerium compound and precipitating agent to be present in the oxidation vessel. This embodiment of the invention eliminates the need for an extra vessel and thereby reduces the cost of installing and operating the process of the invention.

Although the precipitating agent can be any material, solid or liquid, that reacts with the oxidized contaminant (e.g., arsenate or other species containing arsenic in the +5 oxidation state) to form insoluble arsenic compounds, it is usually a particulate solid that contains cations in the +3 oxidation state, which cations react with the oxidized contaminant (e.g., arsenate) to form insoluble contaminant compounds. Examples of such solids containing cations in the +3 oxidation state include alumina, gamma-alumina, activated alumina, acidified alumina such as alumina treated with hydrochloric acid, metal oxides containing labile anions such as aluminum oxychloride, crystalline aluminosilicates such as zeolites, amorphous silica-alumina, ion exchange resins, clays such as montmorillonite, ferric sulfate, porous ceramics, and cerium compounds containing cerium in the +3 oxidation state, such as cerous carbonate. Although lanthanum oxide and other rare earth compounds can be used as the precipitating agent, these materials are typically not employed (except of course for cerium compounds) in the process of the invention because it is preferred to use a precipitating agent that has a much smaller Ksp than that of the rare earth compounds.

As mentioned above it is normally preferable that the oxidant (e.g., the cerium +4 compound) and precipitating agent both be present in the oxidation vessel so that the contaminant is oxidized and precipitated essentially simultaneously in the same vessel. Although the cerium +4 compound and precipitating agent can both be water-soluble, it is normally preferred that the cerium +4 compound and precipitating agent both be water-insoluble particulate solids that are either slurried with the aqueous feed in the oxidation vessel or physically mixed together in a fixed bed through which the aqueous feed is passed during the oxidation step. In an alternative embodiment of the invention, the cerium +4 compound can be deposited on the surface and/or in the pores of the solid precipitating agent. This embodiment is normally not preferred over a physical mixture because supporting the cerium compound on or in the precipitating solids requires the cerium compound to be dissolved in a liquid, the resultant solution mixed with the support solids, and the wet solids dried. Such steps add significantly to the cost of practicing the process of the invention.

Normally, a sufficient amount of the cerium +4 compound is present in the oxidation vessel with the particulate precipitating agent so that the mixture of the two contains between about 8 and 60 weight percent of the cerium +4 compound calculated as the oxide. Preferably, the mixture will contain between about 10 and 50 weight percent, more preferably between about 20 and 30 weight percent, of the cerium +4 compound calculated as the oxide. However, in some instances, it may be desirable for the mixture to contain greater than 40 to 45 weight percent of the cerium +4 compound calculated as the oxide.

Regardless of whether the cerium +4 compound is present in the oxidation vessel in admixture with the particulate precipitating agent or supported on or in the pores of the precipitating agent, the solids will typically range in diameter between about 0.25 and 1.5, preferably from 0.5 to 1.0, millimeters. When the cerium +4 compound and precipitating agent are present in the oxidation zone as a fixed bed, it is normally preferred that the particles be spherical in shape so the flow of 10 the aqueous feed through the bed is evenly distributed. However, if desired, the particles may take other shapes including that of extrudates. Such extrudates would typically have a length between about 0.2 and about 3.0 millimeters.

During the oxidation step of the process of the invention when the oxidant is cerium +4, arsenite in the aqueous feed is oxidized to arsenate according to the following equation:

Ce⁺⁴+AsO₂⁻¹→Ce⁺³+AsO₄⁻³

As the cerium +4 oxidizes the arsenite, it is reduced to cerium in the +3 oxidation state, which then reacts with the arsenate formed during the oxidation step to produce insoluble cerium arsenate as shown in the following equation:

Ce⁺³+AsO₄⁻³→CeAsO_{4(solid)}

Although theoretically there is enough cerium +3 formed by reduction of cerium +4 to react with all of the arsenate formed in the oxidation reaction to precipitate the arsenate, it is normally preferred that an additional precipitating agent be present. This agent, which can be a compound containing cerium +3, reacts with any unreacted arsenate to form an insoluble precipitate, which is removed from the aqueous feed to produce the desired arsenic-depleted aqueous liquid.

The oxidation step that takes place in the oxidation vessel is normally carried out at ambient pressure, at a temperature from about 4° to 100° C., preferably from about 5° to 40° C., and at a pH greater than about 3.0. The residence time of the aqueous feed in the oxidation vessel typically ranges from about 2.0 to about 30 minutes. When the cerium +4 compound is the oxidant and the cerium +4 compound and precipitant are both solid particulates and present together as a fixed bed in the oxidation vessel, 10 the precipitated arsenic compounds will be sorbed by or otherwise associated with the solid particles of the precipitating agent so that the aqueous fluid exiting the oxidation vessel will contain essentially no solids and very little arsenic, usually less than about 10 ppb and quite frequently less than 2.0 ppb. If the precipitating agent is not in the oxidation vessel, the effluent from the vessel is passed to another vessel where it is treated separately with the arsenic precipitating agent. Finally, if the cerium +4 compound and precipitating agent are particulate solids that are slurried with the aqueous feed in the oxidation vessel, the effluent from the vessel is normally treated to separate the solids, including the insoluble arsenic compounds formed in the vessel, from the arsenic-depleted liquid. Although the separation can be carried out in any type of device capable of removing particulates from liquids, a filtration system is typically employed.

If the aqueous feed to the process of the invention contains other contaminants that must be removed in addition to arsenic to produce the desired purified aqueous product, the removal of these contaminants is typically carried either before or after the oxidation step. If the other contaminants will interfere with the oxidation of the arsenic, they should be removed prior to the oxidation step. In some cases the process of the invention is also effective for removing other contaminants from the aqueous feed in addition to or to the exclusion of arsenic.

In a preferred embodiment of the invention, an arsenic purifying device containing a cartridge or filter is used to treat residential drinking water. The treating device can be a free standing container with a filtering device containing the composition of the invention or a cartridge type device designed to fit under a sink. These devices are situated so that the water entering the home or business location passes through the filter or cartridge before it enters the sink faucet. The filter and cartridge devices are quite simple and comprise a inlet attached to the source of the drinking water, a filter or cartridge containing the oxidant, preferably the cerium +4 oxidizing agent, usually in the form of a fixed bed and in admixture with an arsenic precipitant, and an outlet in communication with the sink faucet to direct the arsenic-depleted drinking water exiting the cartridge or filter to the entrance of the faucet. Alternatively, a cartridge or filter type device can be designed to fit onto the faucet so that water exiting the faucet passes through the cartridge or filter device before it is consumed.

In the filter or cartridge, arsenic in the +3 oxidation state is oxidized to arsenic in the +5 oxidation state, and substantially all of the dissolved arsenic +5 present reacts with cerium in the +3 oxidation state and the arsenic precipitating agent to form insoluble arsenic compounds that are sorbed onto the fixed bed solids. The precipitating agent is preferably alumina or an ion exchange resin. The effluent exiting the fixed bed and the outlet of the cartridge or filter device will typically have an arsenic concentration less than about 2.0 ppb. After the fixed bed in one of the cartridge or filter devices becomes saturated with arsenic, the cartridge or filter is replaced with a new cartridge or filter of the same or similar design. The spent cartridge or filter is then disposed of in a legally approved manner.

In another embodiment, the process of the invention is used in community water treatment facilities to remove arsenic from drinking water before the water is distributed to local homes and businesses. For such use the oxidant (preferably including the cerium +4 oxidizing agent) is typically present in large tanks in either slurry form or in a fixed bed so that relatively large amounts of arsenic-containing water can be treated either in a continuous or batch mode. The arsenic precipitant can be present either in the tank with the oxidant or in a separate vessel fed by the effluent from the tank. The water exiting the process typically has an arsenic concentration less than about 10 ppb, usually less than 5.0 ppb, and preferably less than 2.0 ppb.

The nature and objects of the invention are further illustrated by the following example, which is provided for illustrative purposes only and not to limit the invention as defined by the claims. The example shows that arsenic in the +3 and +5 oxidation state can be completely removed from water using a cerium dioxide oxidizing agent. Although the experiments focus on cerium dioxide as the oxidizing agent, it is to be understood that other oxidants, whether or not containing a rare earth, may be used to oxidize the arsenic. In addition, though the oxidant and precipitant are discussed with reference to a liquid, particularly an aqueous solution, it is to be understood that the teachings herein are equally applicable to non-aqueous solutions and gases, which may or may not contain water vapor. In the latter situation, the arsenic is in the vapor or aerosol phase (e.g., present as entrained liquid droplets).

### EXAMPLE 1

Test solutions were prepared to mimic arsenic containing groundwater by mixing certified standard solutions of arsenic in the +3 and +5 oxidation states with tap water containing no arsenic. Twenty grams of lanthanum oxide (La₂O₃), 20 grams of cerium dioxide (CeO₂), and a mixture of 10 grams of lanthanum oxide and 10 grams of cerium dioxide were separately placed in a sealed 100 milliliter glass container and slurried with about 96 milliliters of test solutions containing 100 ppb of arsenic +3, 100 ppb of arsenic +5, and 50 ppb of both arsenic +3 and arsenic +5. The resultant slurries were agitated with Teflon coated magnetic stir bar for 15 minutes. After agitation, the tap water was separated from the solids by filtration through Whatman #41 filter paper and sealed in 125 milliliter plastic sample bottles. The bottles were then sent to a certified drinking water analysis laboratory where the amount of arsenic in each sample was determined by graphite furnace atomic absorption spectroscopy. The results of these tests are set forth below in Table 1.

TABLE 1

| | Arsenic | | | | |
|---|---|---|---|---|---|
| | in Water | | | | |
| | Before Test | | Slurried | | |
| Test | ppb | ppb | Material | Arsenic in Water | Arsenic Removed |
| No. | As⁺³ | As⁺⁵ | Percent | After Test ppb | Percent |
| 1 | 0 | 0 | 0 | 0 | N/A |
| 2 | 50 | 50 | 0 | 100 | 0 |
| 3 | 50 | 50 | 100% La₂O₃ | 45 | 55 |
| 4 | 50 | 50 | 100% CeO₂ | 0 | 100 |
| 5 | 50 | 50 | 50% La₂O₃ | 0 | 100 |
| | | | 50% CeO₂ | | |
| 6 | 100 | 0 | 50% La₂O₃ | 0 | 100 |
| | | | 50% CeO₂ | | |
| 7 | 0 | 100 | 50% La₂O₃ | 0 | 100 |
| | | | 50% CeO₂ | | |
| 8 | 0 | 0 | 50% La₂O₃ | 0 | N/A |
| | | | 50% CeO₂ | | |

The data for test 3 in the table show that, when lanthanum oxide is used by itself, only 55 percent of the arsenic present in the arsenic-spiked tap water is removed. Since the solubility of lanthanum arsenate, which contains arsenic +5, is very small, it was assumed that the arsenic remaining in solution was primarily arsenic +3 in the form of arsenite. The results of test 4, on the other hand, show that cerium dioxide can remove all of the arsenic from the water. The disparity in these results is attributed to the fact that cerium exists in the +4 oxidation state in cerium dioxide and is a strong oxidizing agent, whereas the lanthanum in the lanthanum oxide, which is in the +3 oxidation state, is not an oxidizing agent. Although the lanthanum +3 reacts with arsenic in the +5 oxidation state to precipitate it from the water, the lanthanum does not react with the arsenic in the +3 oxidation state. The cerium in the cerium dioxide oxidizes the arsenic +3 to arsenic +5, which then reacts with cerium +3 formed by the reduction of cerium +4 to precipitate all of the arsenic dissolved in the water. Tests 5-7 show that equal mixtures of cerium dioxide and lanthanum oxide are also effective in removing all of the arsenic from the tap water.

### EXAMPLES 2-4

A test solution containing 1.0 ppmw chromium calculated as Cr was prepared by dissolving reagent grade potassium dichromate in distilled water. This solution contained Cr⁺⁶ in the form of oxyanions and no other metal oxyanions. A mixture of 0.5 gram of lanthanum oxide (La₂O₃) and 0.5 gram of cerium dioxide (CeO₂) was slurried with 100 milliliters of the test solution in a glass container. The resultant slurries were agitated with a Teflon coated magnetic stir bar for 15 minutes. After agitation, the water was separated from the solids by filtration through Whatman #41 filter paper and analyzed for chromium using an inductively coupled plasma atomic emission spectrometer. This procedure was repeated twice, but instead of slurrying a mixture of lanthanum oxide and cerium dioxide with the 100 milliliters of test solution, 1.0 gram of each was used. The results of these three tests are set forth below in Table 1.

| | Oxyanion | | | | |
|---|---|---|---|---|---|
| | in Water | | | Oxyanion in | Oxyanion |
| Example | Before Test | | Slurried | Water After | Removed |
| Number | Element | (ppmw) | Material | Test (ppmw) | (percent) |
| 1 | Cr | 1.0 | 0.5 gm La₂O₃ | ≦0.013 | ≧98.7 |
| | | | 0.5 gm CeO₂ | | |
| 2 | Cr | 1.0 | 1.0 gm CeO₂ | ≦0.001 | ≧99.9 |
| 3 | Cr | 1.0 | 1.0 gm La₂O₃ | ≦0.015 | ≧98.5 |
| 4 | Sb | 1.0 | 0.5 gm La₂O₃ | ≦0.016 | ≧98.4 |
| | | | 0.5 gm CeO₂ | | |
| 5 | Sb | 1.0 | 1.0 gm CeO₂ | ≦0.016 | ≧98.4 |
| 6 | Sb | 1.0 | 1.0 gm La₂O₃ | ≦0.100 | ≧90.0 |
| 7 | Mo | 1.0 | 0.5 gm La₂O₃ | ≦0.007 | ≧99.3 |
| | | | 0.5 gm CeO₂ | | |
| 8 | Mo | 1.0 | 1.0 gm CeO₂ | ≦0.001 | ≧99.9 |
| 9 | Mo | 1.0 | 1.0 gm La₂O₃ | ≦0.009 | ≧99.1 |
| 10 | V | 1.0 | 1.0 gm La₂O₃ | ≦0.004 | ≧99.6 |
| | | | 1.0 gm CeO₂ | | |
| 11 | V | 1.0 | 1.0 gm CeO₂ | 0.120 | 88.0 |
| 12 | V | 1.0 | 1.0 gm La₂O₃ | ≦0.007 | ≧99.3 |
| 13 | U | 2.0 | 0.5 gm La₂O₃ | ≦0.017 | ≧98.3 |
| | | | 0.5 gm CeO₂ | | |
| 14 | U | 2.0 | 1.0 gm CeO₂ | 0.500 | 75.0 |
| 15 | U | 2.0 | 1.0 gm La₂O₃ | ≦0.050 | ≧95.0 |
| 16 | W | 1.0 | 0.5 gm La₂O₃ | ≦0.050 | ≧95.0 |
| | | | 0.5 gm CeO₂ | | |
| 17 | W | 1.0 | 1.0 gm CeO₂ | ≦0.050 | ≧95.0 |
| 18 | W | 1.0 | 1.0 g La₂O₃ | ≦0.050 | ≧95.0 |

As can be seen the lanthanum oxide, the cerium dioxide and the equal mixture of each were effective in removing over 98 percent of the chromium from the test solution.

### EXAMPLES 5-7

The procedures of Examples 2-4 were repeated except that a test solution containing 1.0 ppmw antimony calculated as Sb was used instead of the chromium test solution. The antimony test solution was prepared by diluting, with distilled water, a certified standard solution containing 100 ppmw antimony along with 100 ppmw each of As, Be, Ca, Cd, Co, Cr, Fe, Li, Mg, Mn, Mo, Ni, Pb, Se, Sr, Ti, Tl, V, and Zn. The results of these tests are also set forth in Table 1 and show that the two rare earth compounds alone or in admixture were effective in removing 90 percent or more of the antimony from the test solution.

### EXAMPLES 8-10

The procedures of Examples 2-4 were repeated except that a test solution containing 1.0 ppmw molybdenum calculated as Mo was used instead of the chromium test solution. The molybdenum test solution was prepared by diluting with distilled water a certified standard solution containing 100 ppmw molybdenum along with 100 ppmw each of As, Be, Ca, Cd, Co, Cr, Fe, Li, Mg, Mn, Ni, Pb, Sb, Se, Sr, Ti, Tl, V, and Zn. The results of these tests are set forth in Table 1 and show that the lanthanum oxide, the cerium dioxide and the equal weight mixture of each were effective in removing over 99 percent of the molybdenum from the test solution.

### EXAMPLES 11-13

The procedures of Examples 2-4 were repeated except that a test solution containing 1.0 ppmw vanadium calculated as V was used instead of the chromium test solution. The vanadium test solution was prepared by diluting, with distilled water, a certified standard solution containing 100 ppmw vanadium along with 100 ppmw each of As, Be, Ca, Cd, Co, Cr, Fe, Li, Mg, Mn, Mo, Ni, Pb, Sb, Se, Sr, Ti, Tl, and Zn. The results of these tests are set forth in Table 1 and show that the lanthanum oxide and the equal weight mixture of lanthanum oxide and cerium dioxide were effective in removing over 98 percent of the vanadium from the test solution, while the cerium dioxide removed about 88 percent of the vanadium.

### EXAMPLES 14-16

The procedures of Examples 2-4 were repeated except that a test solution containing 2.0 ppmw uranium calculated as U was used instead of the chromium test solution. The uranium test solution was prepared by diluting a certified standard solution containing 1,000 ppmw uranium with distilled water. This solution contained no other metals. The results of these tests are set forth in Table 1 and show that, like in Examples 11-13, the lanthanum oxide and the equal weight mixture of lanthanum oxide and cerium dioxide were effective in removing the vast majority of the uranium from the test solution. However, like in those examples, the cerium dioxide was not as effective removing about 75 percent of the uranium.

### EXAMPLES 17-19

The procedures of Examples 2-4 were repeated except that a test solution containing 1.0 ppmw tungsten calculated as W was used instead of the chromium test solution. The tungsten test solution was prepared by diluting a certified standard solution containing 1,000 ppmw tungsten with distilled water. The solution contained no other metals. The results of these tests are set forth in Table 1 and show that the lanthanum oxide, cerium dioxide, and the equal weight mixture of lanthanum oxide and cerium dioxide were equally effective in removing 95 percent or more of the tungsten from the test solution.

Although this invention has been described by reference to several embodiments of the invention, it is evident that many alterations, modifications and variations will be apparent to those skilled in the art in light of the foregoing description. Accordingly, it is intended to embrace within the invention all such alternatives, modifications and variations that fall within the spirit and scope of the appended claims.

We claim:

1. A method, comprising:
(a) treating a contaminant-containing feed in an oxidation zone to oxidize said contaminant; and
(b) removing, by a rare earth-containing precipitant, said oxidized contaminant from said treated feed to form a purified stream having a reduced contaminant concentration as compared to said feed.

2. The method defined by claim 1, wherein the oxidation is performed by an oxidant, wherein the contaminant is arsenic, wherein the oxidant contains a sufficient amount of cerium in the +4 oxidation state to oxidize the arsenic and thereby reduce said cerium to the +3 oxidation state, wherein the feed is an aqueous solution, and wherein arsenic in the +3 oxidation state in said aqueous feed is oxidized to arsenic in the +5 oxidation state in said oxidation zone.

3. The method defined by claim 2, wherein arsenite (AsO₂⁻¹) in said aqueous feed is oxidized to arsenate (AsO₄⁻³) in said oxidation zone and wherein the rare earth-containing precipitant comprises a rare earth selected from the group consisting of lanthanum, cerium, praseodymium, neodymium, promethium, samarium, europium, gadolinium, terbium, dysprosium, holmium erbium, thulium, ytterbium, lutetium, and mixtures thereof.

4. The method defined by claim 2, wherein said cerium-containing compound is a particulate solid.

5. The method defined by claim 4, wherein said cerium-containing compound comprises cerium dioxide (CeO₂).

6. The method defined by claim 1, wherein the precipitant is supported by a substrate, the substrate being selected from the group consisting of alumina, gamma-alumina, activated alumina, acidified alumina, metal oxides containing labile anions, amorphous silica-alumina, ion exchange resins, clays, ferric sulfate, porous ceramics, and mixtures and composites thereof.

7. The method defined by claim 3, wherein said arsenate (AsO₄⁻³) is removed from said aqueous feed by reaction with said rare earth in the +3 oxidation state to produce an insoluble rare earth arsenate.

8. The method defined by claim 1, wherein said precipitant comprises cerium (III) and wherein the oxidized contaminant is removed from said aqueous feed by said cerium (III) to form insoluble arsenic compounds.

9. The method defined by claim 8, wherein said contaminant precipitating agent comprises particulate solid containing rare earth cations in the +3 oxidation state.

10. The method defined by claim 1, wherein the oxidation is performed by an oxidant, wherein said oxidant comprises a rare earth compound.

11. The method defined by claim 10, wherein said oxidant comprises a cerium compound containing cerium in the +4 oxidation state.

12. The method defined by claim 1, wherein said treating and removing steps are carried out in the substantial absence of lanthanum.

13. The method defined by claim 1, wherein the treating step is carried out in said oxidation zone at a temperature between about 5° C. and about 40° C.

14. The method defined by claim 1, wherein the contaminant is arsenic and wherein said feed is selected from the group consisting of groundwater, drinking water, industrial wastewater, agricultural water, lake water, wetlands water and geothermal water.

15. The method defined by claim 14, wherein the concentration of arsenic in said purified aqueous liquid is less than about 10 ppb and wherein the rare earth-containing precipitant comprises one or more of ceric ammonium nitrate, ceric ammonium sulfate, ceric sulfate, and ceric nitrate.

16. The method defined by claim 4, wherein the oxidant comprises a rare earth and wherein said precipitant comprises a reduced rare earth resulting from the oxidation of arsenic by the rare earth in the oxidant.

17. A method, comprising:
(a) treating a feed in an oxidation zone with a rare earth-containing oxidant to oxidize arsenic in an oxidation state less than +5 to arsenic in the +5 oxidation state; and
(b) removing arsenic in the +5 oxidation state from said treated aqueous feed by contacting said treated feed with a rare earth-containing precipitant that reacts with said arsenic in the +5 oxidation state to form an insoluble arsenic compound, thereby forming a purified stream having a reduced arsenic concentration as compared to said feed.

18. The method defined by claim 17, wherein said rare earth-containing oxidant comprises cerium dioxide (CeO₂) and wherein said cerium dioxide (CeO₂) is supported on said particulate solids.

19. The method defined by claim 18, wherein said cerium dioxide (CeO₂) is mixed with said particulate solids and wherein said rare earth-containing precipitant comprises cerium (III).

20. The method defined by claim 17, wherein arsenic in the +3 oxidation state in the form of arsenite (AsO₂⁻¹) is oxidized in said oxidation zone to arsenic in the +5 oxidation state in the form of arsenate (AsO₄⁻³) and wherein said rare earth-containing precipitant comprises a rare earth selected from the group consisting of lanthanum, cerium, praseodymium, neodymium, promethium, samarium, europium, gadolinium, terbium, dysprosium, holmium erbium, thulium, ytterbium, lutetium, and mixtures thereof.

21. The method defined by claim 20, wherein said rare earth-containing precipitant is supported on a substrate and wherein the substrate is selected from the group consisting of alumina, gamma-alumina, activated alumina, acidified alumina, metal oxides containing labile anions, amorphous silica-alumina, ion exchange resins, clays, ferric sulfate, porous ceramics, and mixtures and composites thereof.

22. The method defined by claim 17, wherein said steps (a) and (b) are carried out in the substantial absence of lanthanum.

23. The method defined by claim 19, wherein the combination of said cerium dioxide (CeO₂) and said particulate solids contains between about 10 weight percent and about 50 weight percent cerium dioxide (CeO₂) calculated as the oxide.

24. The method defined by claim 17, wherein the concentration of arsenic in said purified aqueous liquid is less than about 2.0 ppb and wherein the rare earth-containing precipitant comprises one or more of ceric ammonium nitrate, ceric ammonium sulfate, ceric sulfate, and ceric nitrate.

25. A composition, comprising:
an oxidant to oxidize a contaminant; and
a rare earth-containing precipitant to form a precipitate with the oxidized contaminant.

26. The composition defined by claim 25, wherein the contaminant has an oxidation state of at least one of +3 and +5, wherein the contaminant is an oxyanion, and wherein the oxidant comprises cerium (IV) and the precipitant comprises cerium (III).

27. The composition defined by claim 25, wherein said oxidant and precipitant are supported on a substrate and wherein the substrate is selected from the group consisting of alumina, gamma-alumina, activated alumina, acidified alumina, metal oxides containing labile anions, amorphous silica-alumina, ion exchange resins, clays, ferric sulfate, porous ceramics, and mixtures and composites thereof.

28. The composition defined by claim 27, essentially devoid of lanthanum.

29. The composition defined by claim 27, essentially devoid of all rare earths except cerium.

30. The composition defined by claim 27, wherein the oxidant comprises a rare earth having an oxidation number of at least +4 and the precipitant comprises a rare earth having an oxidation number of no more than +3.

31. A device, comprising:
(a) an inlet communicating with a source of drinking water comprising a contaminant;
(b) a vessel containing a rare earth oxidant and rare earth precipitant and having an entry portion and an exit portion, said entry portion communicating with said inlet, the rare earth oxidant to oxidize the contaminant and the rare earth precipitant to remove the oxidized contaminant from the drinking water; and
(c) an outlet communicating with said exit portion of said vessel.

32. The device defined by claim 31, wherein the rare earth oxidant comprises cerium dioxide (CeO₂), wherein the contaminant comprises arsenic, and wherein said vessel contains cerium dioxide (CeO₂) in combination with particulate solids that react with arsenic in the +5 oxidation state to form insoluble arsenic compounds.

33. The device defined by claim 32, wherein said vessel comprises a cartridge containing said cerium dioxide (CeO₂), and said device is designed to fit beneath a sink or on the outlet of a faucet.

34. The device defined by claim 32, wherein said vessel comprises a tank containing cerium dioxide (CeO₂).
